(19) United States
(12) Patent Application Publication
(10) Pub. No.: US 2009/0029146 A1
(43) Pub. Date: Jan. 29, 2009

(54) Mesoporous Particles

(76) Inventors: Justin Derek Holmes, County Cork (IE); John Paul Hanrahan, County Tipperary (IE); Michael Anthony Morris, County Cork (IE); Trevor Richard Spalding, Cork (IE)

Correspondence Address: JACOBSON HOLMAN PLLC, 400 SEVENTH STREET N.W., SUITE 600, WASHINGTON, DC, 20004, US

(21) Appl. No.: 11/887,930

(22) PCT Filed: Apr. 5, 2006
(86) PCT No.: PCT/IE2006/000024

§ 371 Date: Oct. 5, 2007

(30) Foreign Application Priority Data
Apr. 5, 2005 (IE) 2005/0196

(51) Int. Cl. C01B 13/14

(52) U.S. Cl. 428/317.9; 423/592.1

(57) ABSTRACT

A method for synthesising metal oxide particles comprises preparing a pre-sol solution, and hydrolysing and condensing the pre-sol solution under supercritical fluid conditions to form macroscopic mesoporous particles having ordered pore structures. The pre-sol solution may contain a mixture of surfactants such as CTAB and P123. The supercritical fluid may be scCO₂. The mesoporous particles may be spheres with a mesopore diameter in the range of 2 to 15 nm and macroscopic diameters of from 1 to 5 microns. The particles are useful in chromatography and other applications.

The present invention relates to the synthesis of mesoporous particles useful in the chromatography, absorbents and separation industries.

### INTRODUCTION

Chromatography plays an important role in the enrichment and separation of synthetic and natural compounds in the chemical, pharmaceutical, medical and biological industries [1]. High-performance liquid chromatography (HPLC) is currently the most commonly applied technique for separating and analysing multi-component mixtures. The chromatographic properties of the stationary phase are influenced by the size, shape, surface and porosity properties of the material. Stationary phases based on silica are very popular due to their stability to high pressure and variation in pH. Typically, porous micrometer-sized silica spheres, between 3 and 7 μm in diameter, are often used as chromatography stationary phases due to their moderate surface areas (200 and 400 m² g⁻¹) and good packing efficiency. However, there are a number of limitations with using currently commercially available silica particles as chromatography stationary phases. In particular, milling is a commonly used technique to obtain silica particles of the required size but often results in the production of irregular shaped particles. Chromatography columns prepared with irregular shaped particles often show poor column longevity, due to the rearrangement of the particles in the packing during separation, ultimately resulting in poor separation efficiencies. There is also a limitation with respect to particle size control using milling technology. Producing particle size below 5 μm is extremely inefficient and expensive. The orientation of the internal pores is random, and the distribution of diameters within each particle is large, resulting in only moderate surface areas. Such materials are less effective at separating almost identical solutes, e.g. biphenyl from naphthalene.

Mesoporous silica particles have been proposed as stationary phases for size-exclusion chromatography [2], HPLC [3], capillary-gas chromatography [4] and chiral HPLC [5]. However, highly ordered mesoporous silica particles are difficult to prepare with controllable and reproducible pore diameters. Additionally, poor hydrothermal stability and problems associated with directing the macroscopic particle size and shape often make the preparation of these materials problematic.

There is a need to prepare high-quality mesoporous particles for advanced chromatographic, absorbent and separation applications.

### STATEMENTS OF INVENTION

According to the invention there is provided a method for synthesising metal oxide particles comprising the steps of:—
preparing a pre-sol solution; and
hydrolysing and condensing the pre-sol solution under supercritical fluid conditions to form macroscopic mesoporous particles having ordered pore structures.

In one embodiment of the invention the pre-sol solution contains a mixture of surfactants.

The mixture of surfactants may include an ionic surfactant such as a cationic surfactant.

In one embodiment the presol solution contains cetyltrimethylammonium bromide (CTAB).

In one embodiment the surfactant includes a diblock (A-B) or triblock copolymer (A-B-A or A-B-C). The diblock (A-B) or triblock copolymers (A-B-A or A-B-C) may be copolymers having polyethylene oxide (PEO), polypropylene oxide (PPO) and polybutylene oxide (PBO) segments.

In one embodiment the presol solution contains P123 (PEO₂₀PPO₆₉PEO₂₀).

The supercritical fluid (SCF) may be selected from any one or more of carbon dioxide, xenon, ammonia and alkanes of the formula CₓH₂ₓ₊₁ such as propane and butane wherein x is an integer between 1 and 6.

In one embodiment the SCF is supercritical carbon dioxide.

In one case the macroscopic mesoporous particles are prepared under pressure to provide supercritical fluid conditions. The pressure may be between 10 and 1000 bar. Preferably the pressure is greater than 150 bar.

In one case the particles are prepared at a pressure between 10 and 600 bar.

In one embodiment the method comprises the step of washing, filtering and drying the mesoporous particles.

The surfactant(s) may be removed from the mesoporous particles by calcination. The mesoporous particles may be calcined in air and/or air-ozone mixtures at a temperature between 200 and 600° C. The mesoporous particles may be calcined in air and/or air-ozone mixtures for between 1 and 24 hours.

Alternatively or additionally the surfactant(s) is removed from the mesoporous particles by microwave irradiation in the presence of an alcohol-type solvent. The alcohol-type solvent may be selected from any one or more of ethanol, methanol, 1-propanol and 2-propanol.

In one embodiment the pre-sol solution is prepared by hydrolysis of a metal oxide precursor in the presence of a solvent, a surfactant mixture, an acid hydrolysis catalyst, water and a supercritical fluid.

The surfactant mixture may be present at a concentration of less than 20% by weight of the pre-sol solution. In one case the surfactant mixture is present at a concentration of less than 10% by weight of the pre-sol solution.

In one embodiment the metal oxide precursor is selected from any one or more of tetraethoxysilane (TEOS), tetramethoxysilane (TMOS), tetrapropoxysilane (TPOS), tetrabutoxysilane (TBOS), tetra-acetoxysilane, tetrachlorosilane and organic derivative thereof. The organic derivative may have the formula RₙSiX₍₄₋ₙ₎ wherein R is an organic radical and X is a hydrolysable group selected from any one or more of halide, acetoxy, alkoxy, teramethysilane and tetraethysilane and n is an integer between 1 and 4.

The solvent may be an alcohol-type solvent. The alcohol-type solvent may be selected from any one or more of ethanol, methanol, 1-propanol, 2-propanol and 1-butanol.

In one embodiment the acid catalyst is a mineral or organic acid. The acid catalyst may be selected from any one or more of hydrochloric (HCl), nitric, sulfuric, phosphoric, acetic and citric acid. The acid catalyst may be present in a concentration range of between 0.001 M and 1M.

In one embodiment the pre-sol solution is prepared at a temperature of between −5 and 80° C. The pre-sol solution may be heated to a temperature of between 0 and 60° C. The pre-sol solution may be left to stand for at least 1 minute and up to 48 hours. In one case the pre-sol solution is left to stand for at least 1 minute and up to 24 hours.

The ratio of the surfactants can be varied. For example, in the case of the surfactants P123 and CTAB, the ratio P123:CTAB could be varied in a typical range of 0.007:0.001 to 0.007:0.10, preferably in the range of 0.007:0.005 to 0.007:0.06. These ratios are based on the TEOS having a ratio of 1.0 relative to P123 and CTAB.

In one embodiment the method comprises the step of adding a dopant compound to the pre-sol solution. The dopant compound may comprises aluminium or boron. The dopant compound may be selected from any one or more of aluminium nitrate, aluminium isopropoxide and triethyl borane.

The invention also provides mesoporous particles synthesised by a method of the invention.

In one embodiment the mesoporous particles have a mesopore diameter between 2 and 30 nm.

The mesoporous particles may have a mesopore diameter between 2 and 15 nm.

In one case the mesoporous particles have a mesopore diameter between 5 and 15 nm.

The particles may have a mesopore diameter of greater than 5 nm.

The mesoporous particles may have a pore volume between 0.3 and 1 cm³g⁻¹.

The mesoporous particles may have a surface area between 300 and 1000 m²g⁻¹.

The mesoporous particles may be in the form of spheres, rods, discs or ropes.

In one embodiment the mesoporous particles have macroscopic diameters of between 1 and 10 μm.

The mesoporous particles may have macroscopic diameters between 1 and 5 μm.

In one embodiment the mesoporous particles are in the form of spheres.

In one case the mesoporous particles are ordered in a single direction.

The mesoporous particles may comprise a mesopore diameter greater than 5 nm, a pore volume between 0.3 and 1 cm³g⁻¹, a surface area between 300 and 1000 m²g⁻¹ and macroscopic diameters between 1 and 10 μm.

The invention also provides mesoporous silica particles in the form of spheres, rods, discs or ropes prepared by a method as claimed in any of claims 1 to 49.

A mesoporous particle comprising a mesopore diameter greater than 5 nm, a pore volume between 0.3 and 1 cm³g⁻¹, a surface area between 300 and 1000 m²g⁻¹ and macroscopic diameters between 1 and 10 μm.

The invention also provides mesoporous particle comprising a mesopore diameter greater than 5 nm, a pore volume between 0.3 and 1 cm³g⁻¹, a surface area between 300 and 1000 m²g⁻¹ and macroscopic diameters between 1 and 5 μm.

The invention also provides the use of macroscopic mesoporous particles of the invention in a chromatography stationary phase.

The invention further provides a chromatography stationary phase comprising metal oxide macroscopic mesoporous particles of ordered pore structures prepared by preparing a pre-sol solution and hydrolysing and condensing the pre-sol solution under supercritical fluid conditions. The macroscopic mesoporous particles may comprise a pore diameter of greater than 5 nm, a pore volume between 0.3 and 1 cm³g⁻¹, a surface area between 300 and 1000 m²g⁻¹ and macroscopic diameters between 1 and 10 μm.

According to the invention there is also provided a method for synthesising metal oxide macroscopic mesoporous particles of ordered pore structures comprising the steps of:—
preparing a pre-sol solution; and
hydrolysing and condensing the pre-sol solution under supercritical fluid conditions.

In one embodiment of the invention the pre-sol solution is prepared by hydrolysis of a metal oxide precursor in the presence of a solvent, a structural directing agent, an acid hydrolysis catalyst, water and a supercritical fluid.

In one embodiment of the invention the structural directing agent comprises a surfactant. Preferably the structural directing agent comprises at least two surfactants.

In one embodiment of the invention the surfactant(s) is present at a concentration of less than 20% by weight of the pre-sol solution. Preferably the surfactant(s) is present at a concentration of less than 10% by weight of the pre-sol solution.

In one embodiment of the invention the surfactant is selected from any one or more of diblock (A-B) or triblock copolymers (A-B-A or A-B-C), polyalkyl ethers, anionic surfactants and cationic surfactants. The diblock (A-B) or triblock copolymers (A-B-A or A-B-C) may be copolymers having polyethylene oxide (PEO), polypropylene oxide (PPO) and polybutylene oxide (PBO) segments. Preferably the surfactant is P123 (PEO₂₀PPO₆₉PEO₂₀)

In one embodiment of the invention the polyalkyl ethers comprise ethers of the formula CₓH₂ₓ₊₁—(CH₂—CH₂O)_{y}H wherein x are integers between 12 and 18 and y are integers between 2 and 24. Preferably the polyalkyl ether is a Brij surfactant such as Brij 30.

In one embodiment of the invention the anionic surfactant is sodium bis(2-ethylhexyl)sulfosuccinate (AOT).

In another embodiment of the invention the cationic surfactant is cetyltrimethylammonium bromide (CTAB).

In one embodiment of the invention the metal oxide precursor is selected from any one or more of tetraethoxysilane (TEOS), tetramethoxysilane (TMOS), tetrapropoxysilane (TPOS), tetrabutoxysilane (TBOS), tetra-acetoxysilane, tetrachlorosilane and organic derivative thereof. Preferably the organic derivative has the formula RₙSiX₍₄₋ₙ₎ wherein R is an organic radical and X is a hydrolysable group selected from any one or more of halide, acetoxy, alkoxy, teramethysilane and tetraethysilane and n is an integer between 1 and 4.

In one embodiment of the invention the solvent is an alcohol-type solvent selected from any one or more of ethanol, methanol, 1-propanol, 2-propanol and 1-butanol.

The acid catalyst is a mineral or organic acid selected from any one or more of hydrochloric (HCl), nitric, sulfuric, phosphoric, hydrofluoric (HF), acetic and citric acid.

In one embodiment of the invention the acid catalyst is present in a concentration range of between 0.001 M and 1M.

In one embodiment of the invention the pre-sol solution is prepared at a temperature of between −5 and 80° C.

In another embodiment of the invention the pre-sol solution is heated to a temperature of between −5 and 80° C. for up to 2 hours.

The invention also provides a method as hereinbefore described comprising the step of adding a dopant compound to the pre-sol solution to improve hydrothermal stability of the mesoporous materials produced. Preferably the dopant compound comprises aluminium or boron. The dopant compound may be selected from any one or more of aluminium nitrate, aluminium isopropoxide and triethyl borane.

In one embodiment of the invention the pre-sol solution is left to stand for at least 1 minute and up to 48 hours depending on the degree of structural ordering required. Preferably the pre-sol solution is left to stand at a temperature of between 0 and 80° C.

In one embodiment of the invention the mesoporous particles are dried at a temperature of between 200 and 550° C.

In another embodiment of the invention the pre-sol solution is hydrolysed and condensed using a supercritical fluid (SCF) or mixture of SCFs. Preferably the supercritical fluid is selected from any one or more of carbon dioxide, xenon, ammonia and alkanes of the formula CₓH₂ₓ₊₁ such as propane and butane wherein x is an integer between 1 and 6. Most preferably the SCF is supercritical carbon dioxide.

In one embodiment of the invention the particles are treated at a temperature of between 30 and 500° C. and at a pressure between 1 and 1000 bar.

One embodiment of the invention comprises the step of washing, filtering and drying the mesoporous particles.

In one embodiment of the invention the particles are treated at a temperature between 250 and 550° C. and at a pressure between 10 and 600 bar.

In one embodiment of the invention the surfactant(s) is removed from the mesoporous particles by calcination. The mesoporous particles are calcined in air and/or air-ozone mixtures at a temperature between 200 and 600° C. Preferably the mesoporous particles are calcined in air and/or air-ozone mixtures for between 1 and 24 hours.

In another embodiment of the invention the surfactant(s) may be removed from the mesoporous particles by microwave irradiation in the presence of an alcohol-type solvent selected from any one or more of ethanol, methanol, 1-propanol and 2-propanol.

In one embodiment of the invention the mesoporous particles have a mesopore diameter between 2 and 30 nm, preferably between 2 and 15 nm, most preferably greater than 5 nm.

In one embodiment of the invention the mesoporous particles have a pore volume between 0.3 and 1 cm³g⁻¹, a surface area between 300 and 1000 m²g⁻¹.

The mesoporous particles may be in the form of spheres, rods, discs or ropes.

In one embodiment of the invention the mesoporous particles have macroscopic diameters of between 1 and 10 μm. The mesoporous particles may have macroscopic diameters between 1 and 5 μm and are in the form of spheres.

In one embodiment of the invention the mesoporous particles are ordered in a single direction.

The invention further provides mesoporous particles synthesised by a method as hereinbefore described.

The invention also provides mesoporous particles prepared by a method hereinbefore described comprising a mesopore diameter greater than 5 nm, a pore volume between 0.3 and 1 cm³g⁻¹, a surface area between 300 and 1000 m²g⁻¹ and macroscopic diameters between 1 and 10 μm.

One aspect of the invention provides mesoporous silica particles in the form of spheres, rods, discs or ropes.

The invention further provides a mesoporous particle comprising a mesopore diameter greater than 5 nm, a pore volume between 0.3 and 1 cm³g⁻¹, a surface area between 300 and 1000 m²g⁻¹ and macroscopic diameters between 1 and 10 μm.

The invention also provides use of macroscopic mesoporous particles as hereinbefore described in a chromatography stationary phase. The particles may be macroscopic mesoporous silica particles.

The invention further provides a chromatography stationary phase comprising metal oxide macroscopic mesoporous particles of ordered pore structures prepared by preparing a pre-sol solution and hydrolysing and condensing the pre-sol solution under supercritical fluid conditions. Preferably the macroscopic mesoporous particles comprise a pore diameter of greater than 5 nm, a pore volume between 0.3 and 1 cm³g⁻¹, a surface area between 300 and 1000 m²g⁻¹ and macroscopic diameters between 1 and 10 μm.

### DEFINITION

A mesoporous particle comprises a sphere, rod, disc or rope and is taken to include a particle in which the mesopores are arranged within the particle in an ordered arrangement with symmetry described as hexagonal, cubic or lamellar. In this way an ordered mesoporous structure is not the same as a random mesoporous arranged formed from tortuous mesopores resulting for example from trapped volumes between particles in a solid. The ordered mesoporous structures formed here are similar to materials previously described using the acronyms MCM (Mobil Composition of Matter) or SBA (Santa Barbara Adsorbents) and have a pore size range between 2 and 15 nm.

The term macroscopic is taken to include sizes of the order of 100 nm and greater. An organic template is taken to include a defined structural arrangement originating from the assembly of surfactant molecules in a solvent as defined by the solvent-surfactant interactions. The organic template can also be described as a structural directing agent (SDA).

Typical surfactants used as mesoporous SDAs are polyethylene oxide (PEO)-polypropylene oxide (PPO)-polyethylene oxide (PEO) triblock copolymer surfactants with the general chemical formula of PEOₓ-PPO_{y}-PEOₓ. A co-surfactant, or SDA, typically cetyltrimethylammonium bromide (CTAB), is used to control the macroscopic structure of the particles (sphere, rod, disc or rope).

An inorganic precursor is a chemical compound that can be reacted with other chemical compounds to produce an oxide material. This oxide will form around the organic template structure to form an inorganic oxide skeleton which will survive treatments to remove the organic SDA component. An example of an inorganic precursor is a metal alkoxide such as tetraethoxysilane (TEOS). In the presence of the SDAs, solvent and other materials, TEOS hydrolyses to yield a molecule and molecular assemblies containing hydroxide groups. These hydroxyl group containing species react by elimination of water to produce -M-O-M- (M representing a metal ion and O and oxygen ion) bonds. This process is known as condensation. The product of the condensation reaction is a poorly chemically, structurally and stoichiometrically defined solid or gel containing metal oxide, metal hydroxide and metal-organic bonds. A dilute gel which flows easily on pouring is termed a sol.

A supercritical fluid is defined as an element, compound or mixture above its critical temperature (T_{c}) or critical pressure (P_{c}) below which state changes can be effected by changes in temperature and/or pressure.

A supercritical fluid treatment is defined as a procedure in which a pre-sol solution is hydrolysed and condensed in a supercritical fluid environment to form a sol of mesoporous silica particles.

A pre-sol is a mixture of chemicals which under certain conditions will react to form a sol of mesoporous silica particles.

Calcination is described as a thermal treatment under air. As an alternative, mixtures of air and ozone may be used as this ensures complete removal of organic materials.

### BRIEF DESCRIPTION OF DRAWINGS

The invention will be more clearly understood from the following description thereof given by way of example only with reference to the accompanying figures in which:—

FIG. 1 is a flow diagram illustrating a process according to the invention;

FIG. 2 is a scanning electron micrograph image of mesoporous silica spheres prepared by a method of the invention from TEOS:P123:EtOH:CTAB:HCl ratios of 1:0.007:9:0.027:22.6, treated with sc-CO₂ at a pressure of 206 bar (Scale bar=8 μm);

FIG. 3 are transmission electron micrograph (TEM) images of a mesoporous silica sphere taken at two different magnifications at (a) 100 nm and (b) 25 nm, prepared using sc-CO₂ at a pressure of 206 bar, from a molar ratio of TEOS:P123:EtOH:CTAB:HCl of 1:0.007:9:0.027:22.6;

FIG. 4 is a graph showing the PXRD patterns of mesoporous silica spheres processed in sc-CO₂ using a chemical molar ratio of TEOS:P123:EtOH:CTAB:HCl of 1:0.007:9:0.027:22.6 at varying CO₂ pressures;

FIG. 5 is a graph showing pore size distributions, calculated from N₂ sorption profiles, for sc-CO₂ treated and untreated samples of mesoporous silica spheres manufactured using the following molar ratio of TEOS:P123:EtOH:CTAB:HCl of 1:0.007:9:0.027:22.6 at (i) 0 bar, (ii) 137 bar and (iii) 486 bar; and

FIG. 6 is a graph showing the UV-visible absorption data for biphenyl, 2,2-bipyridyl and 4,4-bipyridyl separated on a chromatographic column using sc-CO₂ treated mesoporous silica particles as the stationary phase (conditions: solvent 1: hexane−elutes biphenyl; solvent 2: 50% hexane diethyl+trace amount acetic acid−elutes 2,2-bipyridyl and solvent 3: 100% diethyl ether to elute 4,4-bipyridyl).

### DETAILED DESCRIPTION

We have found a simple and reproducible method for preparing high quality ordered mesoporous particles using supercritical fluid processing techniques. The method allows the preparation of uniform particles, with tunable mesoporous and macroscopic morphologies, in particular mesoporous silica particles in the form of spheres, rods, discs and ropes.

By careful control of the reaction conditions, such as the amount and type of surfactants used and the pressure of the supercritical fluid, the pore size and structure of the mesoporous layers can be predetermined.

Using the method of the invention we are able to prepare macroscopic mesoporous materials of regular, predictable and controlled shape. Previously the control of both the macroscopic and mesoporous properties of such materials has been difficult to achieve on a consistent basis.

The method provides mesoporous particles with a narrow size distribution and ordered internal pores. Such materials have large surface areas and are very effective for use in chromatographic, absorbent and separation applications.

Mesoporous silicas offer a number of advantages over current commercially available porous silica spheres which include:
i) high surface areas, typically between 500 and 1000 m² g⁻¹, providing superior separating ability as a chromatographic matrix. A high surface area, and hence high capacity factor (k′), should effectively allow the separation of chiral enantiomers.
ii) well defined, tunable pore sizes. Mesoporous silica is typically produced using a micelle-templated polymerisation method which produces uni-directional, size-monodisperse particles. In mesoporous silica powders the size of these pores can readily be tuned to between 2 and 30 nm [6]. However, most mesoporous silica spheres produced have mesopore diameters between 2 and 4 nm. The ability to control mesopore diameters has important implications for the use of these materials in size-exclusion chromatography. Also, for the effective separation of bio-macromolecules such as proteins, mesoporous silica spheres with large pore diameters, >6 nm, are desirable.
iii) ordered porosity, i.e. in hexagonal mesoporous silica all the pores are ordered in one direction. This ordered porosity enhances column efficiency for high flow rates compared to commercially available mesoporous silicas, by providing higher and more homogeneous molecular diffusion [3a]. This offers the possibility to separate compounds much faster without a significant loss in column efficiency, resulting in increased productivity.
iv) spherical particles of mesoporous Silica can be produced without milling. A number of technologies have been reported for forming spherical mesoporous particles including spray-drying, oil-drop and pseudomorphic synthesis [3a, 7].

The mesoporous materials of the invention may also be relevant to the catalysis industry as support materials and to the general materials market, including highly specific chemical sensors and opto-electronic devices. In particular, the invention relates to the preparation of mesoporous particles with defined macroscopic dimensions, such as spheres, rods, discs and ropes using a supercritical fluid (SCF) assisted approach. The SCF process does not affect the hexagonal ordering in the mesoporous particles, a distinct advantage over conventional pore swelling techniques. Consequently, spherical particles, with macroscopic diameters between 1 and 10 μm, and highly ordered, size-tunable mesopores, between 2 and 15 nm in diameter can be produced by the SCF methodologies of the invention.

Mesopore dimensions may be tuned utilizing a SCF, such as supercritical carbon dioxide (sc-CO₂), as part of the process. Spherical particles are produced in a similar manner to those reported by Zhang et al. [8]. In the preparation, micelles formed from triblock copolymer surfactants, of polyethylene (PEO)-polypropylene (PPO)-polyethylene oxide (PEO), such as P123 (PEO₆₉-PPO₂₀-PEO₆₉), are mixed with a silica precursor, such as tertraethoxysilane (TEOS) and an ionic surfactant, such as cetyltrimethylammonium bromide (CTAB), under acid conditions (termed a pre-sol solution) and processed to form mesoporous materials. By changing the acid conditions size-monodispersed spherical particles with tunable macroscopic diameters, i.e. between 1 and 10 μm can be formed. Processing of the pre-sol solution in a super critical fluid results in the controlled swelling of the mesopores to between 2 and 15 nm. The invention provides a method for synthesising swelled mesoporous silica materials with uni-directional and tunable mesoporous diameters. Control of mesopore diameters, within mesoporous silica powders has formerly been achieved through the addition of swelling agents or by changing the surfactant templating agent [9]. However, the use of swelling agents has been shown to diminish the long-range ordering of the mesopores and also disrupt the delicate chemical composition of the reacting materials. Swelling agents can also disturb the reaction stoichiometry and lead to a loss of ordering. Previously we have shown a method for tailoring the pore size of hexagonal mesoporous silica ‘powders’ using supercritical carbon dioxide (sc-CO₂) as a swelling agent during the silica densification process [10]. In the present invention we use a SCF expansion method, during the hydrolysis and condensation process, to obtain large pore mesoporous particles, including spheres. The method has the following advantages over mesoporous silica spheres synthesised by other procedures:
i) particles can be produced which are spherical and relatively size-monodispersed allowing for efficient column packing. The particles themselves are not aggregated or linked as reported in a number of other methods.
ii) the particles are thermally (up to 850° C.), mechanically and chemically robust. This results from the use of triblock copolymers to template the mesoporous spheres. Traditionally, ionic surfactants have been used as templating surfactants but these produce much less robust materials.
iii) the mesopore diameters of the particles can be controlled between 2 and 15 nm. Most mesoporous silica spheres produced to date have pore sizes between 2 and 4 nm. sc-CO₂ has been shown to control the pore size within mesoporous silica powders with Angstrom-level precision [9b].
iv) the mesoporous particles act as effective stationary phases for chromatographic separations.

The surfactants used may be but are not limited to any one or more of diblock (A-B) or triblock copolymers (A-B-A or A-B-C), with polyethylene oxide (PEO), polypropylene oxide (PPO) or polybutylene oxide (PBO) segments, polyalkyl ethers, e.g CₓH₂ₓ₊₁-(CH₂—CH₂O)_{z}H (CₓEO_{y}) such as Brij surfactants, anionic surfactants, such as sodium bis(2-ethylhexyl)sulfosuccinate (AOT) and cationic surfactants, e.g. cetyltrimethylammonium bromide (CTAB) and Triton-X.

The alcohol-type solvent used may be but is not limited to any one or more of ethanol, propanol or butanol.

A suitable silating agent may be but is not limited to any one or more of tetraethoxysilane (TEOS), tetramethoxysilane (TMOS), tetrapropoxysilane (TPOS), and tetrabutoxysilane (TBOS), tetra-acetoxysilane, tetrachlorosilane or organic derivative thereof represented by the formula RₙSiX₍₄₋ₙ₎ where R is an organic radical and X is a hydrolysable group such as halide, acetoxy, alkoxy, teramethysilane, tetraethysilane.

A suitable supercritical fluid as a porogenic swelling agent may be, but is not limited to any one or more of carbon dioxide, xenon, ammonia and alkanes (CₓH₂ₓ₊₁) such as ethane, propane and butane.

The metal oxide source used to prepare the sol may be but is not limited to, an alkoxide, carboxylate or halide of silicon, boron, cerium, lanthanum, yttrium, titanium, zirconium, vanadium, molybdenum, tungsten or hafnium.

Control of the surfactant concentration used in the preparation of the silica mesoporous particles allows the resulting pore structure of the particle to be determined. Hexagonal and lamellar structures have parallel arrangements of pores and porous surfaces respectively. Cubic structures have channels running through the entire particle that allow transport to and from the surface. This may be a desirable characteristic for porous particles used in adsorbent, catalysis or sensor devices and applications.

Preferably the swelling of the mesoporous particles is carried out at low concentrations of surfactant, preferably at concentrations less than 20 wt %. The swelling process involves the use of two surfactants and swelling is carried out during the hydrolysis process.

The method of the invention provides the following advantages; 1. The ability to prepare robust mesoporous particles with greater thermal robustness than conventionally prepared materials and in certain cases alleviates significant experimental difficulties in the synthesis of these materials. 2. The use of sc-CO₂ leads to increased hexagonal mesoscopic ordering within the particles. 3. The method is simple and can be widely applied. 4. The method is not limited to particular surfactants or mixtures thereof and so the synthesis allows the control the pore size and structure of the mesoporous particles to be determined. 5. Mesoporous particles can be consistently formed. 6. The methods are consistent with techniques whereby mixed metal mesoporous oxide particles can be prepared.

The invention will be more clearly understood by the following examples.

### EXAMPLES

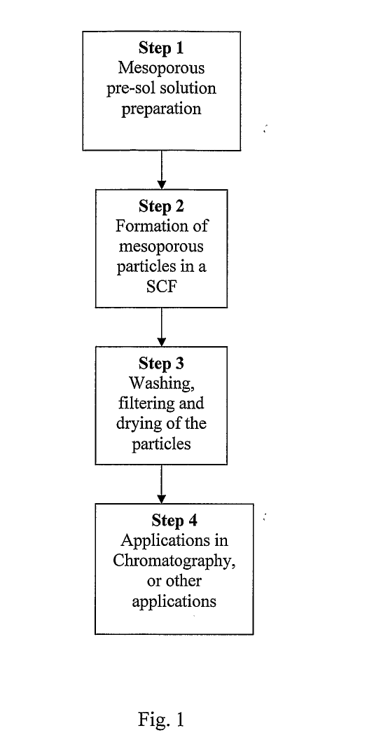

Mesoporous silica particles are prepared in several stages, as represented schematically in FIG. 1 and described below:

Step 1: This is the SCF treatment and is responsible for achieving large pore mesoporous particles with very high thermal stability that exhibit high degrees of ordered mesoporosity. In this process the silicon compound is mixed with the following ingredients: a suitable solvent, which in most cases is an alcohol, a mixture of structure directing agents (surfactant templates), an acid hydrolysis catalyst and controlled amount of water to produce a pre-sol solution. The pre-sol solution may be prepared at temperatures between −5 and 80° C. The pre-sol solution should be clear and free from any visible particles to produce high quality mesoporous particles.

Step 2: The pre-sol solution prepared in step 1 may be prepared in a high pressure cell and exposed to a fluid such that the pressure and temperature of the fluid are above the critical values. The sample may be heated (up to 500° C.) under pressure (between 2 and 1000 bar) during this treatment. The purpose of this process is to allow hydrolysis of the silicon compound and cross-linking of the inorganic polymer chains (condensation process) in a SCF atmosphere to form a sol of mesoporous particles.

Step 3: The particles are removed from the SCF process, washed, filtered, air dried for up to 4 days and further calcined at temperatures between 200 and 550° C. for periods of a few minutes to several days in air or air/ozone mixtures. Alternatively, the particles are exposed to microwave irradiation between 40 and 1000 watt in the presence of a solvent which in most cases is an alcohol to extract the SDA. Oxide particles are formed which consist of open pores, i.e. no organic surfactant is present.

Step 4: The mesoporous particles can be packed into traditional chromatography columns, with typical dimensions such as diameter 1.0 cm and length 30 cm, using traditional ‘wet filling’ techniques, i.e. the mesoporous silica is wetted with a solvent to produce a slurry which is delivered into the column. A liquid sample of the mixture to be chromatographed is dissolved in a solvent, typically dichloromethane, and placed on top of the column. The starting column solvent (hexane in the first two cases) is then placed into the column. A hand pump can then be used to generate the required pressure to force the solvent through the column to separate the mixture's components.

### Example 1

### Preparation of Mesoporous Silica Spheres

Mesoporous silica spheres were prepared based on modified methods described by Ma et al. [11] and Zhang et al. [12] Tetraethoxysilane (TEOS) was used as the silica source, while P123 (PEO₂₀PPO₆₉PEO₂₀) and cetyltrimethylammonium bromide (CTAB) acted as the mixed surfactant templates. Ethanol (EtOH) were used as the co-solvent.

0.3 g of P123 and 0.05 g of CTAB were mixed together in a high-pressure cell with 100 ml of 1.6 M HCl and was left stirring (400 rpm) for 2 hr. 3 ml of EtOH and 1.5 ml of TEOS were added to the solution. The pressure cell was then sealed. Supercritical carbon dioxide (sc-CO₂) was introduced into the pressure cell which was thermostated at a temperature of 60° C. and kept a constant pressure of 500 bar. The solid product was removed from the pressure cell after 4 days and washed. It was air-dried at 60° C. for 1 day. Calcination of the surfactant template was performed at 550° C. for 8 hr. Highly ordered mesoporous silica spheres were produced with the following molar ratio; TEOS:P123:EtOH:CTAB:HCl was 1:0.007:9:0.027:22.6. Table 1 illustrates the molar composition and physiochemical properties of a variety of mesoporous silica particles synthesised. It will be apparent that by selection of the surfactant type, surfactant ratio, temperature and pressure the pore size and structure may be varied.

TABLE 1

| | | | | Pore | | | | | |
|---|---|---|---|---|---|---|---|---|---|
| | | CO₂ | Particle | to | d- | Pore | Pore | Surface | |
| | | Pressure | Size | Pore | spacing | Dia | Wall | Area | |
| Sample | Surfactant | (bar) | (μm) | (nm) | (nm) | (nm) | (nm) | (m²g⁻¹) | Shape |
| SBA^{a} | P123 | — | — | 10.4 | 9.0 | 6.2 | 4.2 | 850 | Fiber |
| SBA^{a} | P123 | — | — | 10.2 | 8.9 | | | | Fiber |
| SBA/CO₂^{a} | P123 | 206 | — | 10.9 | 9.5 | | | | Fiber |
| SBA/CO₂^{a} | P123 | 482 | <1 | 10.1 | 9.5 | 8.0 | 2.1 | 601 | Fiber |
| UCC/CTAB/EtOH^{b} | P123/CTAB | — | — | 10.5 | 9.2 | 6.2 | 4.3 | 826 | Irregular |
| | | | | | | | | | Spheres |
| UCC/CTAB/EtOH/CO₂^{b} | P123/CTAB | 68 | <1 | 10.6 | 9.2 | 6.1 | 4.5 | 900 | Irregular |
| | | | | | | | | | spheres |
| UCC/CTAB/EtOH/CO₂^{b} | P123/CTAB | 137 | <1 | 10.8 | 9.4 | 7.1 | 3.7 | 765 | Irregular |
| | | | | | | | | | spheres |
| UCC/CTAB/EtOH/CO₂^{b} | P123/CTAB | 206 | 3 | 11.1 | 9.7 | 9.0 | 2.1 | 642 | Spheres |
| UCC/CTAB/EtOH/CO₂^{b} | P123/CTAB | 275 | 3 | 11.3 | 9.6 | 9.5 | 1.8 | 678 | Spheres |
| UCC/CTAB/EtOH/CO₂^{b} | P123/CTAB | 344 | 3 | 12.0 | 10.3 | 10.1 | 1.9 | 598 | Spheres |
| UCC/CTAB/EtOH/CO₂^{b} | P123/CTAB | 482 | 3 | 13.1 | 11.4 | 10.9 | 2.2 | 501 | Spheres |
| UCC/CTAB/EtOH/CO₂^{c} | P123/CTAB | 482 | 2 | 12.6 | 11.8 | 10.5 | 2.1 | 567 | Spheres |
| UCC/CTAB/EtOH/CO₂^{d} | P123/CTAB | 482 | 5 | 13.1 | 11.3 | 10.8 | 2.3 | 489 | Spheres |
| UCC/CTAB/Al(NO₃)₃/CO₂ | P123/CTAB | 344 | 0.5 | 10.4 | 9.0 | 8.5 | 1.9 | 598 | Spheres |
| UCC/CTAB/B(OEt)₃/CO₂ | P123/CTAB | 206 | — | — | — | 7.5 | — | 650 | Agglomeration |

^{a}TEOS:P123:HCl 1:0.01:0.24
^{b}TEOS:P123:EtOH:CTAB:HCl 1:0.007:9:0.027:22.6
^{c}TEOS:P123:EtOH:CTAB:HCl 1:0.007:9:0.01:22.6
^{d}TEOS:P123:EtOH:CTAB:HCl 1:0.007:9:0.06:22.6

Powder X-ray diffraction (PXRD) profiles of the mesoporous particles were recorded on a Philips X'Pert diffractometer, equipped with a Cu—K_{α} radiation source and accelerator detector. Height and reflected Stoller slits of 0.2° were used with a programmable divergent slit to maintain a 10 mm footprint at the sample. Sample heights, were determined at θ=2θ=0 at the point when the sample reduced the beam intensity by 50%. The surface areas of the calcined mesoporous silica spheres were measured using nitrogen Brunauer Emmett Teller (BET) isotherms on a Micromeritics Gemini 2375 volumetric analyzer. Each sample was degassed for 12 hr at 200° C. prior to a BET measurement. The average pore size distribution of the calcined silicas was calculated on the Barrett Joyner Halanda (BJH) model from a 30-point BET surface area plot. All the mesoporous silicas examined exhibited a Type IV adsorption isotherm typical of mesoporous solids. Desorption isotherms was used in order to calculate the average pore diameters. A JEOL 2010 (0.5 nm resolution) electron microscope operating with a 100 kV accelerating voltage was used for transmission electron microscopy (TEM). Samples were dispersed in chloroform, and a drop of the mixture was placed on a carbon-coated copper TEM grid. Scanning electron microscopy (SEM) measurements (0.05 μm resolution) were conducted on a JEOL 5510 SEM on samples placed on carbon tape and then adhered to a brass stub. For particle size distribution measurements, a frequency count of 200 spheres was used to determine average sphere size.

FIG. 1 is a flow diagram showing a process according to the invention, illustrating a general method of forming ordered mesoporous silica particles. First, a silica pre-sol solution is made. This may be made directly in a high-pressure cell or in a beaker and then transferred to the high-pressure cell. The hydrolysis and subsequent condensation of this pre-sol solution occurs under a SCF environment. As shown in block 2, the pre-sol solution is condensed as particles in a SCF environment. Finally, as shown in block 3, the particles are calcined to create SDA-free mesoporous particles. These mesoporous particles, as prepared or functionalized with organic species such as silanes containing alkyl chains (Cₙ, n=8-26) such as dimethyloctadecylchlorosilane (CH₃(CH₂)₁₇Si(CH₃)₂Cl; C₁₈), can be packed into chromatography columns, e.g. traditional columns or high pressure liquid chromatography (HPLC), and used as stationary phases for advanced chromatography (block 4).

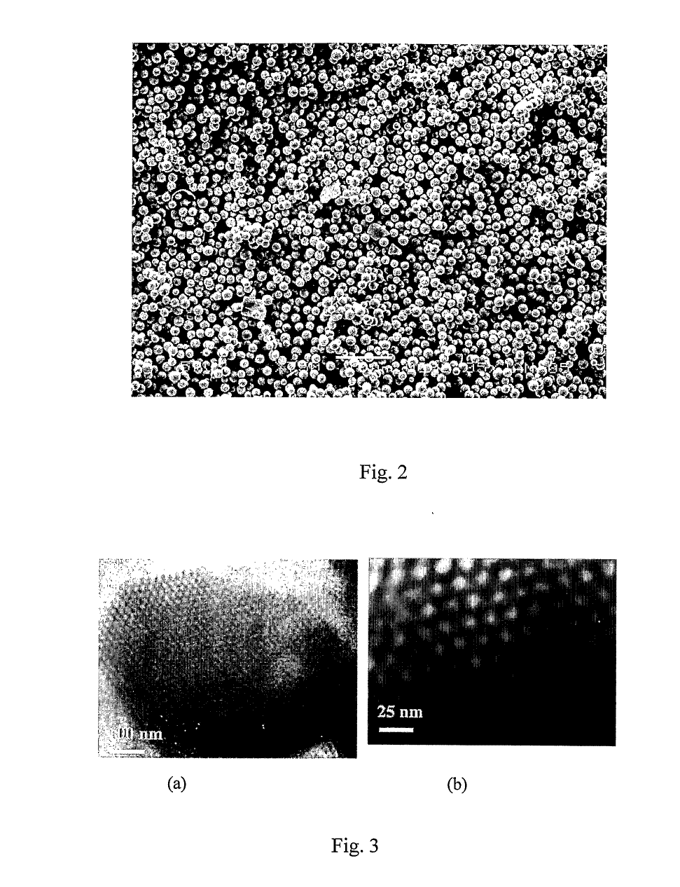

FIG. 2 shows the beneficial effect of using the SCF treatment to form large pore mesoporous silica particles. FIG. 2 shows an example of a mesoporous silica sphere produced using a molar ratio of TEOS:P123:EtOH:CTAB:HCl of 1:0.007:9:0.027:22.6 and treated with sc-CO₂ at a pressure of 206 bar and at a temperature of 60° C. The SEM image confirms that the surface of the sphere is smooth and free from major defects. The particle size and morphology of the mesoporous silica spheres prepared in sc-CO₂ do not differ from those produced in the absence of sc-CO₂ except that the mesopore diameters increase with increasing CO₂ pressure. As shown in table 1, at higher CO₂ pressures (>150 bar) more spherical particulates are formed compared to non-treated samples and those treated a low CO₂ pressures (<150 bar). Samples prepared in the absence of CTAB do not retain the spherical morphology indicating that the co-surfactant is necessary for the production of particles of spherical morphology.

FIG. 3 shows a TEM image illustrating the hexagonal arrangement of the mesopores in a sc-CO₂ prepared mesoporous silica sphere (obtained from the following reaction conditions: a TEOS:P123:EtOH:CTAB:HCl ratio of 1:0.007:9:0.027:22.6 and a CO₂ pressure of 206 bar). The pore diameter was calculated to be 9.0 nm and the pore wall width was calculated to be approx. 2.1 nm, which are in agreement with nitrogen sorption data.

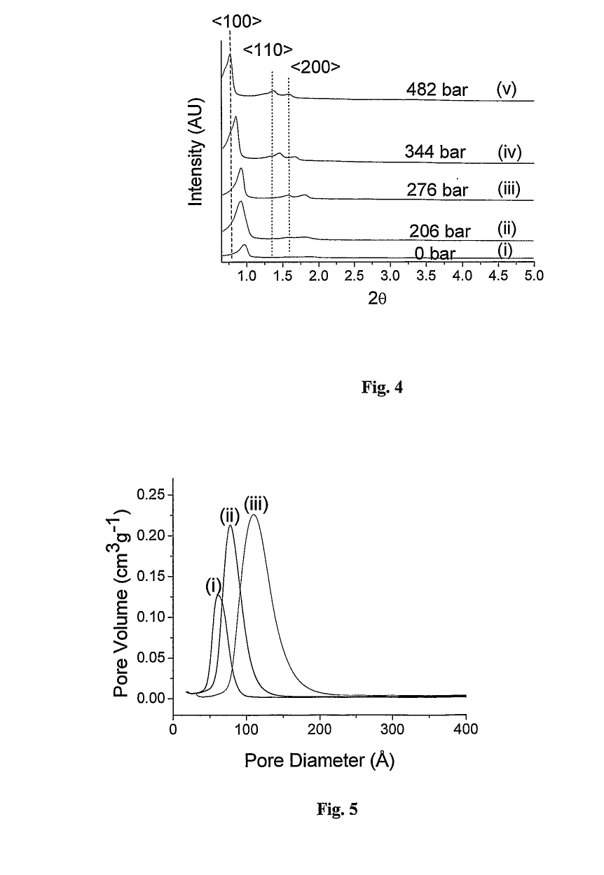

The PXRD patterns shown in FIG. 4 demonstrates the effect of CO₂ treatment on the d-spacing of the calcined mesoporous silica spheres prepared using the following molar ratio of TEOS:P123:EtOH:CTAB:HCl of 1:0.007:9:0.027:22.6. The 2θ values can be seen to shift from 0.97 (untreated silica, line a) to 0.77 (sc-CO₂ treated at 482 bar, line (v) representing an increase in d-spacing from 9.2 to 11.4 nm. The <100>, <200> and <110> reflections can all be clearly indexed but at higher pressures the peaks show greater resolution indicating that the interaction of CO₂ with the reaction mixture has favourable effects on the pore ordering. The presence of three well defined peaks in the sc-CO₂ samples indicates excellent ordering of the mesopores which is generally not observed in mixed surfactant templating methods. Spherical samples prepared in the absence of sc-CO₂ do not show the same degree of ordering.

The variation in the pore diameter of mesoporous silica as a function of CO₂ pressure during the hydrolysis process is shown by the pore size distribution curves in FIG. 5. As the CO₂ pressure is increased the pore diameter increases. The untreated mesoporous silica templated from a P123/CTAB mixture displays a mean pore diameter of 6.2 nm while the mesoporous silica processed under a CO₂ pressure of 482 bar display a mean pore diameter of 10.9 nm. The increase in pore diameter represents a pore expansion of approximately 80%.

### Example 2

### Mesoporous Silica Spheres as Chromatography Stationary Phases

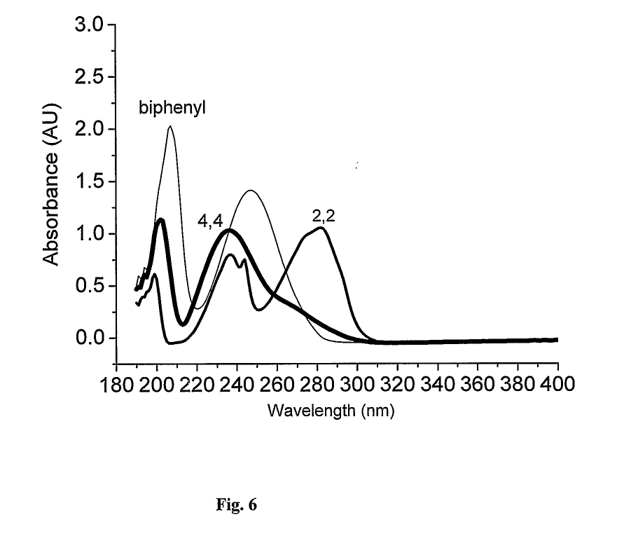

The SCF-treated mesoporous silica particles can be used as stationary phases for chromatography. We have shown the successful separation of (a) the organometallic compounds acetylferrocene and ferrocene and (b) the separation of the organo-bipyridyl compounds (biphenyl, 2,2-bipyridyl and 4,4-bipyridyl) and biphenyl, using SCF-treated mesoporous silica spheres. For the separation of acetylferrocene from ferrocene, the highly coloured nature of these chemical species means that the separation of these two components can be observed visually. UV-visible absorption data for the separation of the organo-bipyridyl compounds (2,2-bipyridyl and 4,4-bipyridyl) and biphenyl, using SCF-treated mesoporous silica spheres as a stationary phase is shown in FIG. 6. The specific mesoporous silica particles used in this example are those described above prepared using UCC/CTAB/EtOH/CO2(b), P123/CTAB, CO₂ pressure of 482 bar, particle size 3 μm and pore diameter of 10.9 nm. Distinctive peaks were noticed for each of the individual species.

### Example 3

### Synthesis of Aluminium Doped Mesoporous Silica Spheres

A typical synthesis for the formation of Al-doped mesoporous silica spheres is outlined. 0.02 g of hexadecyltrimethylammonium bromide (CTAB) and 0.1 g of P123 surfactant was dissolved in 20 ml of 1.6 M HCl to which 0.2 g of aluminium nitrate nanohydrate (Al(NO₃)₃.9H₂O) was added. Once dissolved 0.2 ml of tetraethoxysilane (TEOS) was added to achieve better distribution of metal ions in the framework of the mesoporous materials. The pre-sol solution was transferred to a high pressure cell and pressurized with CO₂ at a pressure of 344 bar. The system was left to stand for between 1 and 7 days. The precipitated sample was washed and dried overnight at 80° C. and calcined for 12 hours at 550° C. Variations to the above synthesis include changing the amount of Al (NO₃)₃.9H₂O added. Low angle PXRD studies of the as-prepared samples showed 3 characteristic peaks that could be identified as the (100), (110) and (200) reflection typical of mesoporous silica materials. Surface area analysis showed the material to have a surface area of 598 m²g⁻¹. The mean mesopore diameter in these particles was found to be 8.5 nm. Scanning electron microscopy (SEM) analysis confirmed the presence of monodispersed spheres of approximately 0.5 μm.

Additionally, Al-doped mesoporous silica may also be prepared by substituting Al(NO₃)₃.9H₂O with aluminium isopropoxide.

Al-doped mesoporous silica spheres have potential applications as nanocatalysis, for example in fine chemical synthesis.

### Example 4

### Synthesis of Boron Doped Mesoporous Silica Spheres

A typical synthesis for the formation of Boron-doped mesoporous silica spheres is outlined. 0.02 g of hexadecyltrimethylammonium bromide (CTAB) and 0.1 g of P123 surfactant was dissolved in 20 ml of 1.6 M HCl to which 0.2 g of triethyl boron (B(CH₂CH₃)₃) was added. Once dissolved 0.2 ml of tetraethoxysilane (TEOS) was added to achieve a better distribution of metal ions in the framework of the mesoporous materials. The pre-sol solution was then transferred to a high pressure cell and pressurized with CO₂ at a pressure of 206 bar. The system was left to stand for between 1 and 7 days. The precipitated sample was washed and dried overnight at 80° C. and calcined for 12 hours at 500° C. Low angle PXRD studies showed 3 characteristic peaks that can be identified as the (100), (110) and (200) reflection typical of mesoporous silica materials. Surface area analysis showed the materials to have a surface area of 650 m²g⁻¹. The mean mesopore diameters in these particles was found to be 7.5 nm.

B-doped mesoporous silica spheres have potential applications as nanocatalysis, for example in fine chemical synthesis.

The invention is not limited to the embodiments hereinbefore described which may be varied in detail. Although specific embodiments, including specific equipment, parameters, methods, and materials have been described, it will be readily understood by those skilled in the art, that various other changes in the details, materials, and arrangements of the materials and steps may be made without departing from the principles and scope of the invention.

### REFERENCES

1) Gallis, K. W.; Eklund, A. G.; Jul, S. J.; Araujo, J. T.; Moore, J. G.; Landry, C. C. in ‘Nanoporous Materials II, Studies in Surface Science and Catalysis’. Sayari, A.; Jaroniec, M; Pinnavaia, T. J. (Eds). Elsevier Science, Oxford; 2000, Vol. 129.
2) Nassivera, T.; Eklund, A. G.; Landry, C. C. J. Chromat. A. 2002, 973, 97.
3) Martin, T. et al. Chem. Mater. 2004, 16, 1725. Ma, Y. et al. Coll. Surf. A 2003, 229, 1. Messa, M. et al. Sol. State Sci. 2003, 5, 1303. Boissière, C. et al. Adv. Func. Mater. 2001, 11, 129. Gallis, K. W. et al. Adv. Mater. 1999, 11, 1452.
4) Raimondo, M.; Perez, G.; Sinibaldi, M.; De Stefanis, A.; Tomlinson, A. A. G. Chem. Commun. 1997, 1343
5) Thoelen, C.; Paul, J.; Vankelecom, I. F. J.; Jacobs, P. A. Tetrahedron: Assymmetry 2000, 11, 4819.
6) Huo, Q. et al. Chem. Mater. 1994, 267, 2068.
7) Lu, Y. et al. Nature 1999, 398, 223. Huo, Q. et al. Chem. Mater. 1997, 9, 14.
8) Zhao, J.; Gao, F.; Fu, Y.; Jin, W.; Yang, P.; Zhao, D. Chem. Commun. 2002, 752.
9) Kimura, T.; Sugahara, Y.; Kuroda, K. J., J. Chem. Soc., Chem. Commun. 1998, 55, 559. Ryan, K. M.; Coleman, N. B.; Lyons, D. M.; Hanrahan, J. P.; Spalding, T. R.; Morris, M. A.; Steytler, D. C.; Heenan, R. K.; Holmes, J. D., Langmuir 2002, 18, 4996.
10) Hanrahan, J. P.; Copley, M. P.; Ryan, K. M.; Spalding, T. R.; Morris, M. A.; Holmes, J. D. Chem. Mater. 2004, 16, 424.
11) Ma, Y.; Qi, L.; Ma, J.; Wu, Y.; Liu, O.; Cheng, H., Colloids and Sufaces A 2003, 229, 1.
12) Zhang, W.-H.; Lu, J.; Han, B.; Li, M.; Xiu, J.; Ying, P.; Li, C., Chem. Mater. 2002, 14, 3413.

1-59. (canceled)

60. A method for synthesising metal oxide particles comprising the steps of:—
i. preparing a pre-sol solution; and
ii. hydrolysing and condensing the pre-sol solution under supercritical fluid conditions to form macroscopic mesoporous particles having ordered pore structures.

61. The method as claimed in claim 60 wherein the pre-sol solution contains a mixture of surfactants.

62. The method as claimed in claim 61 wherein mixture of surfactants includes an ionic surfactant.

63. The method as claimed in claim 61 wherein the mixture of surfactants includes a cationic surfactant.

64. The method as claimed in claim 60 wherein the presol solution contains cetyltrimethylammonium bromide (CTAB).

65. The method as claimed in claim 61 wherein the surfactant includes a diblock (A-B) or triblock copolymer (A-B-A or A-B-C).

66. The method as claimed in claim 65 wherein the diblock (A-B) or triblock copolymers (A-B-A or A-B-C) are copolymers having polyethylene oxide (PEO), polypropylene oxide (PPO) and polybutylene oxide (PBO) segments.

67. The method as claimed in claim 66 wherein the presol solution contains P123 (PEO₂₀PPO₆₉PEO₂₀).

68. The method as claimed in claim 60 wherein the supercritical fluid (SCF) is selected from any one or more of carbon dioxide, xenon, ammonia and alkanes of the formula CₓH₂ₓ₊₁ such as propane and butane wherein x is an integer between 1 and 6.

69. The method as claimed in claim 68 wherein the SCF is supercritical carbon dioxide.

70. The method as claimed in claim 60 wherein the macroscopic mesoporous particles are prepared under pressure to provide supercritical fluid conditions.

71. The method as claimed in claim 70 wherein the pressure is between 10 and 1000 bar.

72. The method as claimed in claim 70 wherein the pressure is greater than 150 bar.

73. The method as claimed in claim 70 wherein the particles are treated at a pressure between 10 and 600 bar.

74. The method as claimed in claim 60 comprising the step of washing, filtering and drying the mesoporous particles.

75. The method as claimed in claim 61 wherein the surfactant(s) is removed from the mesoporous particles by calcination.

76. The method as claimed in claim 75 wherein the mesoporous particles are calcined in air and/or air-ozone mixtures at a temperature between 200 and 600° C.

77. The method as claimed in claim 75 wherein the mesoporous particles are calcined in air and/or air-ozone mixtures for between 1 and 24 hours.

78. The method as claimed in claim 61 wherein the surfactant(s) is removed from the mesoporous particles by microwave irradiation in the presence of an alcohol-type solvent.

79. The method as claimed claim 78 wherein the alcohol-type solvent is selected from any one or more of ethanol, methanol, 1-propanol and 2-propanol.

80. The method as claimed in claim 60 wherein the pre-sol solution is prepared by hydrolysis of a metal oxide precursor in the presence of a solvent, a surfactant mixture, an acid hydrolysis catalyst, water and a supercritical fluid.

81. The method as claimed in claim 61 wherein the surfactant mixture is present at a concentration of less than 20% by weight of the pre-sol solution.

82. The method as claimed in claim 61 wherein the surfactant mixture is present at a concentration of less than 10% by weight of the pre-sol solution.

83. The method as claimed in claim 80 wherein the metal oxide precursor is selected from any one or more of tetraethoxysilane (TEOS), tetramethoxysilane (TMOS), tetrapropoxysilane (TPOS), tetrabutoxysilane (TBOS), tetra-acetoxysilane, tetrachlorosilane and organic derivative thereof.

84. The method as claimed in claim 83 wherein the organic derivative has the formula RₙSiX⁽⁴⁻¹⁾ wherein R is an organic radical and X is a hydrolysable group selected from any one or more of halide, acetoxy, alkoxy, teramethysilane and tetraethysilane and n is an integer between 1 and 4.

85. The method as claimed in claim 80 wherein the solvent is an alcohol-type solvent.

86. The method as claimed in claim 85 wherein the alcohol-type solvent is selected from any one or more of ethanol, methanol, 1-propanol, 2-propanol and 1-butanol.

87. The method as claimed in claim 80 wherein the acid catalyst is a mineral or organic acid.

88. The method as claimed in claim 87 wherein the acid catalyst is selected from any one or more of hydrochloric (HCl), nitric, sulfuric, phosphoric, acetic and citric acid.

89. The method as claimed in claim 87 wherein the acid catalyst is present in a concentration range of between 0.001 M and 1M.

90. The method as claimed in claim 60 wherein the pre-sol solution is prepared at a temperature of between −5 and 80° C.

91. The method as claimed in claim 60 wherein the pre-sol solution is heated to a temperature of between 0 and 60° C.

92. The method as claimed in claim 60 wherein the pre-sol solution is left to stand for at least 1 minute and up to 48 hours.

93. The method as claimed in claim 60 wherein the pre-sol solution is left to stand for at least 1 minute and up to 24 hours.

94. The method as claimed in claim 60 comprising the step of adding a dopant compound to the pre-sol solution.

95. The method as claimed in claim 94 wherein the dopant compound comprises aluminium or boron.

96. The method as claimed in claim 95 wherein the dopant compound is selected from any one or more of aluminium nitrate, aluminium isopropoxide and triethyl borane.

97. The method as claimed in claim 60 wherein the mesoporous particles have a mesopore diameter between 2 and 30 nm.

98. The method as claimed in claim 60 wherein the mesoporous particles have a mesopore diameter between 2 and 15 nm.

99. The method as claimed in claim 60 wherein the mesoporous particles have a mesopore diameter between 5 and 15 nm.

100. The method as claimed in claim 60 wherein the particles have a mesopore diameter of greater than 5 nm.

101. The method as claimed in claim 60 wherein the mesoporous particles have a pore volume between 0.3 and 1 cm³g⁻¹.

102. The method as claimed in claim 60 wherein the mesoporous particles have a surface area between 300 and 1000 m²g⁻¹.

103. The method as claimed in claim 60 wherein the mesoporous particles are in the form of spheres, rods, discs or ropes.

104. The method as claimed in claim 60 wherein the mesoporous particles have macroscopic diameters of between 1 and 10 μm.

105. The method as claimed in claim 60 wherein the mesoporous particles have macroscopic diameters between 1 and 5 μm.

106. The method as claimed in claim 60 wherein the mesoporous particles are in the form of spheres.

107. The method as claimed in claim 60 wherein the mesoporous particles are ordered in a single direction.

108. The mesoporous particles synthesised by a method as claimed in claim 60.

109. The mesoporous esoporous particles prepared by a method as claimed in claim 60 comprising a mesopore diameter greater than 5 nm, a pore volume between 0.3 and 1 cm³g⁻¹, a surface area between 300 and 1000 m²g⁻¹ and macroscopic diameters between 1 and 10 μm.

110. The mesoporous esoporous silica particles in the form of spheres, rods, discs or ropes prepared by a method as claimed in claim 60.

111. A mesoporous particle comprising a mesopore diameter greater than 5 nm, a pore volume between 0.3 and 1 cm³g⁻¹, a surface area between 300 and 1000 m²g⁻¹ and macroscopic diameters between 1 and 10 μm.

112. A mesoporous particle comprising a mesopore diameter greater than 5 nm, a pore volume between 0.3 and 1 cm³g⁻¹, a surface area between 300 and 1000 m²g⁻¹ and macroscopic diameters between 1 and 5 μm.

113. The use of macroscopic mesoporous particles as claimed in claim 108 in a chromatography stationary phase.

114. The use of macroscopic mesoporous silica particles as claimed in claim 108 in a chromatography stationary phase.

115. A chromatography stationary phase comprising metal oxide macroscopic mesoporous particles of ordered pore structures prepared by preparing a pre-sol solution and hydrolysing and condensing the pre-sol solution under supercritical fluid conditions.

116. The chromatography stationary phase as claimed in claim 115 wherein the macroscopic mesoporous particles comprise a pore diameter of greater than 5 nm, a pore volume between 0.3 and 1 cm³g⁻¹, a surface area between 300 and 1000 m²g⁻¹ and macroscopic diameters between 1 and 10 μm.
